(19) United States
(12) Patent Application Publication
(10) Pub. No.: US 2007/0141098 A1
(43) Pub. Date: Jun. 21, 2007

(54) Method and system for dispensing dry bird repellent

(76) Inventor: Gary L. Crawford, Edmonds, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/311,871

(22) Filed: Dec. 19, 2005

(51) Int. Cl. A01N 37/44; A01M 13/00

(52) U.S. Cl. 424/405; 43/125; 514/534

(57) ABSTRACT

Methods and apparatus for dispensing bird repelling chemical solutions, such as a methyl anthranilate (MA) solution in a bird inhalable size, are disclosed. A small particle haze, including a bird repelling chemical, such as MA, is created in an enclosed container. The small particle haze is created by one or more venturi nozzles. The small particle haze is filtered to remove particles in excess of a predetermined size. The remaining particles are combined with a stream of air that separates the particles into a dry haze. The stream of air also directs the combination into a dispensing tube that includes a plurality of outlets for dispensing the dry haze. Relatively small diameter sized dispensing tubes are formed of a relatively rigid material such as polyvinyl chloride (PVC). Larger sized dispensing tubes are inflatable. The air added to inflate inflatable tubes further separates the dry haze particles. Filtering prevents dirt and debris from polluting the dry haze that is created through the mixture of clean dry air with the small bird repellent particles.

### BACKGROUND

In the past, fogging machines have been used to dispense bird repellent chemical solutions, such as solutions containing methyl anthranilate (“MA solutions”). More recently, haze machines for dispensing bird repellent liquid chemical solutions, such as MA solutions, have been developed. More specifically, it has been well known for many years that MA solutions can be used as a bird repellent. MA is avian-specific and non-toxic to humans. Initially, MA was dispensed using fogging machines that created a cloud of chemicals, i.e., a fog. The MA droplets included in the fog irritated the nasal passages of birds, causing the birds to leave and thereafter avoid the fogged area.

The use of fogging machines and other mechanisms for dispensing MA solutions or MA in other forms has a number of disadvantages, some of which are described in detail in U.S. patent application Ser. No. 10/646,089, titled “Hazing a Bird Repellent Solution,” and earlier filed Provisional Application No. 60/405,663, both of which are incorporated herein by reference. Among other disadvantages is the size of the MA droplets included in the fog produced by fogging machines and some misting machines. Unfortunately, the majority of droplets created by fogging machines are larger than desirable. That is, the majority of the MA droplets produced by fogging machines are greater than 20 microns in size. As a result, the MA droplet fog created by fogging machines is somewhat wet, resulting in the creation of a residue on surfaces that come in contact with the fog. Another disadvantage is the visibility of the fog. Birds have keen eyesight. As a result, while they will leave an area when MA fog is present, they will likely return when the fog ends.

Fogging machines have other disadvantages that are described in detail in U.S. patent application Ser. No. 10/646,089 and Provisional Application No. 60/405,663. In order to overcome these disadvantages, haze machines for dispensing bird repellent chemical solutions, such as MA solutions, have been developed. Such machines are described in the foregoing patent application and provisional application. The haze machines described in the foregoing patent application and provisional application include venturi nozzles that employ a Bernoulli effect to create a dry MA haze of small size particles. More specifically, high-pressure air applied to the venturi nozzles of such haze machines causes the nozzles to draw small droplets of MA solution from a reservoir and break the MA droplets into small size particles. The majority of the particles are of a size sufficiently small (20 microns or less) to deeply penetrate the nasal passages of birds. Filtering the particles removes larger than desired particles.

Maintaining MA particle size is important to the successful use of methyl anthranilate (MA) because MA repels birds as a result of birds inhaling small size MA particles. Smaller size particles penetrate deeper into the nasal passages of birds than do larger size particles. As a result, smaller size MA particles are more effective in repelling birds than larger size MA particles. The literature shows that MA particles less than 20 microns in size are the most desirable. Maintaining the small size of MA particles is difficult with most methods of distribution. MA particles have a tendency to coagulate (i.e., combine) if several small MA particles are either released together at the same location, or pushed into a small area and/or around sharp corner. Coagulation is caused by the lack of sufficient space between the MA particles. Coagulation causes small MA particles to become large MA droplets outside of the haze machine generating the MA particles. More specifically, when the MA particles touch, they enlarge and form MA droplets that are wet. The wet droplets drip and form wet areas (i.e., residue) on the surfaces that the droplets contact. Maintaining a separation between small MA particles causes a drying effect on the haze. One way of maintaining a separation between MA particles suggested in the foregoing patent application and provisional application in addition to normal wind movement is the use of a fan positioned outside of a haze machine.

In summary, it has been known for several years that small size MA solution particles (“MA particles”), specifically MA particles smaller than 20 microns, are more effective as a bird repellent than large size MA particles, i.e., particles above 20 microns. Recent testing has shown that the continuous separation of MA particles is important to keeping the size of MA particles below 20 microns.

While haze machines of the type generally described above, and in more detail in U.S. patent application Ser. No. 10/646,089 and Provisional Patent Application No. 60/405,633, have been a significant advance in the dispensing of liquid bird repellents, in particular, MA, such machines and the methods they employ are subject to improvement. The present invention is directed to such improvements particularly with respect to keeping the size of MA particles small.

### SUMMARY

The following is a summary description of the subject matter disclosed herein. It is not intended to limit or interpret the scope of the claimed subject matter.

Methods and related apparatus for dispensing bird repellent chemical solutions, such as a methyl anthranilate (MA) solution, in a bird inhalable size are disclosed. A haze that includes the bird repellent chemical is created in an enclosed container. The enclosed container includes a reservoir of the bird repellent chemical solution. Preferably, the haze is created using one or more venturi nozzles. The venturi nozzles draw the bird repellent chemical solution, preferably through a filter, from the reservoir and break the bird repellent chemical solution into particles of a size suitable for bird inhalation. The resulting small particle haze is filtered, preferably by a layered series of filters, to remove particles in excess of a predetermined size. The separation between the remaining particles is increased by a blower adding air to the filtered particle haze. The added air, in effect, decreases the number of MA particles per cubit unit of the resulting particle/air combination. The result is a dry haze that is substantially invisible. The dry haze is injected by the blower into a distribution system. Preferably, the distribution system includes one or more dispensing tubes that include a plurality of outlets located along the length of the dispensing tubes for dispensing the dry haze. Relatively small diameter dispensing tubes may be formed of a rigid material, such as polyvinyl chloride (PVC), galvanized metal, stainless steel or other material that is not reactive to the bird repellant chemical. Large diameter dispensing tubes may be inflatable, rigid, or collapsible. Inflatable dispensing tubes are preferably inflated by a fan positioned at one end of the tube, upstream of where the liquid droplet haze enters the tubes. While a fan is the most cost effective method, other inflation methods can also be used. Introducing the fan air upstream from the haze, increases the separation between the droplets that form the haze thereby maintaining the small size droplets throughout the system and increasing the amount of dry haze being distributed. More specifically, the air added by the fan, in effect, further decreases the number of particles per cubic unit of the resulting MA particle/air combination.

In accordance with other aspects of this invention, preferably, the enclosed container is located in a housing that also includes a compressor that generates pressurized air for the venturi nozzles. Filtering prevents the compressor from deteriorating as a result of exposure to, or ingestion of, the bird repellent chemical solution.

In accordance with further aspects of this invention, preferably, the blower is also located in the housing. Preferably, the blower comprises a vacuum blower and a truncated cone nozzle connected to the output of the vacuum blower.

As will be readily appreciated from the foregoing summary, the separation between haze particles is increased in various ways as the haze is distributed. The increase in separation is created by adding air to the haze and directing the haze into a suitably large distribution system. Increasing the separation distance between the haze particles prevents the particles from coagulating and becoming large. The end result is the emission of a dry haze that is substantially invisible under normal lighting conditions.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of an exemplary bird repellent haze generator coupled to a relatively small diameter dispensing tube;

FIG. 2 is a pictorial top plan view of a bird repellent haze generator coupled to a relatively large diameter dispensing tube;

FIG. 3 is a side elevation view of the relatively large diameter dispensing tube shown in FIG. 2, vertically suspended;

FIG. 4 is an exploded view of the haze generator illustrated in FIGS. 1 and 2;

FIG. 5 is an elevational, cross-sectional view of the haze generator illustrated in FIGS. 1, 2, and 4;

FIG. 6 is a pictorial view of the haze generator illustrated in FIGS. 1, 2, 4, and 5 from a different angle;

FIG. 7 is a further exploded view of the haze generator illustrated in FIGS. 1, 2, and 4-6; and

FIG. 8 is an electrical schematic diagram of the haze generator illustrated in FIGS. 1, 2, and 4-7.

### DETAILED DESCRIPTION

The literature has established that methyl anthranilate (MA) in varying forms can function as avian-specific repellent. The literature has also established that airborne MA particles less than 20 microns in size (preferably less than 10 microns) greatly improve the use of MA as a bird repellent. It is believed that the reduced size particles penetrate deeper into the nasal passages of birds, thereby causing a greater repellent reaction, i.e., a repellent reaction that better causes birds to leave and not reenter areas where a haze formed of small MA particles has been dispensed. In effect, the MA haze “trains” birds to avoid areas where the MA haze is or has recently been present.

While previously developed MA haze machines have been a significant advance in the use of MA as a bird repellent, previously developed haze machines are subject to improvement. In this regard, previously developed MA haze machines generally comprise two separated units: a compressor and a haze generator. The compressor and the haze generator may be coupled together by a high pressure line that directs compressed air produced by the compressor to the haze generator. As more fully described in U.S. patent application Ser. No. 10/646,089 and Provisional Patent Application No. 60/405,633, more fully referenced above and incorporated herein by reference, previously developed MA haze generators include a tank that is formed of material that is nonreactive to MA solutions. That tank includes a reservoir and one or more pickup tubes for withdrawing fluid from the reservoir, which contains an MA solution. The pickup tubes, with filters for removing dirt or particles to large to be used, connect the reservoir to one or more venturi nozzles. The venturi nozzles include a high (above 25 psi) pressure input connected to the high pressure line from the compressor and a fluid input connected to a pickup tube. The venturi nozzles are designed such that as pressurized air is emitted via an outlet, also called a jet, MA solution is withdrawn from the reservoir. More specifically, the pressurized air, in accordance with the Bernoulli effect, creates a low pressure region that pulls or withdraws very small amounts of the MA solution from the reservoir via a pickup tube through a filter. In addition to withdrawing MA fluid, the small orifice directs very small amounts, i.e., droplets, of MA fluid into the pressurized air pathway, vaporizing the MA fluid into small particles that form a haze-like mist. Prior to exiting the haze generator, large droplets in the mist either strike the inside walls of the reservoir and drain back into the bottom of the reservoir or are removed by a filter and returned to the reservoir.

While haze machines of the type generally described above and described in more detail in the foregoing patent and provisional applications have been a substantial improvement in mechanisms for dispensing MA solutions, such haze machines are subject to improvement. For example, in such haze machines, the compressor and the haze generator may be separated by a substantial distance. Separation was thought to be necessary to prevent any residue created by the MA haze produced by the MA haze generator from having a deleterious effect on the equipment. In this regard, MA solutions in their liquid state are relatively caustic. If the particles that form an MA haze are not separated by large volumes of air, i.e., do not form a dry haze, the particles tend to coagulate into large droplets that form a residue on any surface that the droplets contact. The presence of a residue decreases the life of equipment located in close proximity of an MA haze as compared to the life of similar equipment located in an area not containing MA haze. In addition, while the foregoing patent and provisional applications suggest the use of a fan to disperse the haze generated by an MA haze generator after the haze leaves the generator, fans do not have a precise directional effect, making it difficult to direct MA haze to specific locations in a building or other structure where birds roost.

As will be readily appreciated from the foregoing description, in order to make a dry MA haze it is necessary to at least maintain, and preferably increase, the separation between the small MA particles that form the haze. Increasing the separation between the small MA particles that form the haze stops the particles from touching each other and coagulating. As described more fully below, in accordance with the invention, a dry haze is maintained by adding air to a haze formed of small MA particles. The added air increases the separation between the MA particles, thereby reducing the possibility of coagulation of the individual particles into wet droplets that can form a residue. This result is accomplished by using a blower and, in some embodiments, a fan to increase the volume of air and the movement of air upstream of the haze introduction point.

While the various embodiments of the invention described herein were developed for use with MA solutions and are described in combination with an MA solution as the bird repellent, it is to be understood that embodiments of the invention may work equally well with other bird repellent solutions, as well as with other products suitable for dispensing in a haze or mist form.

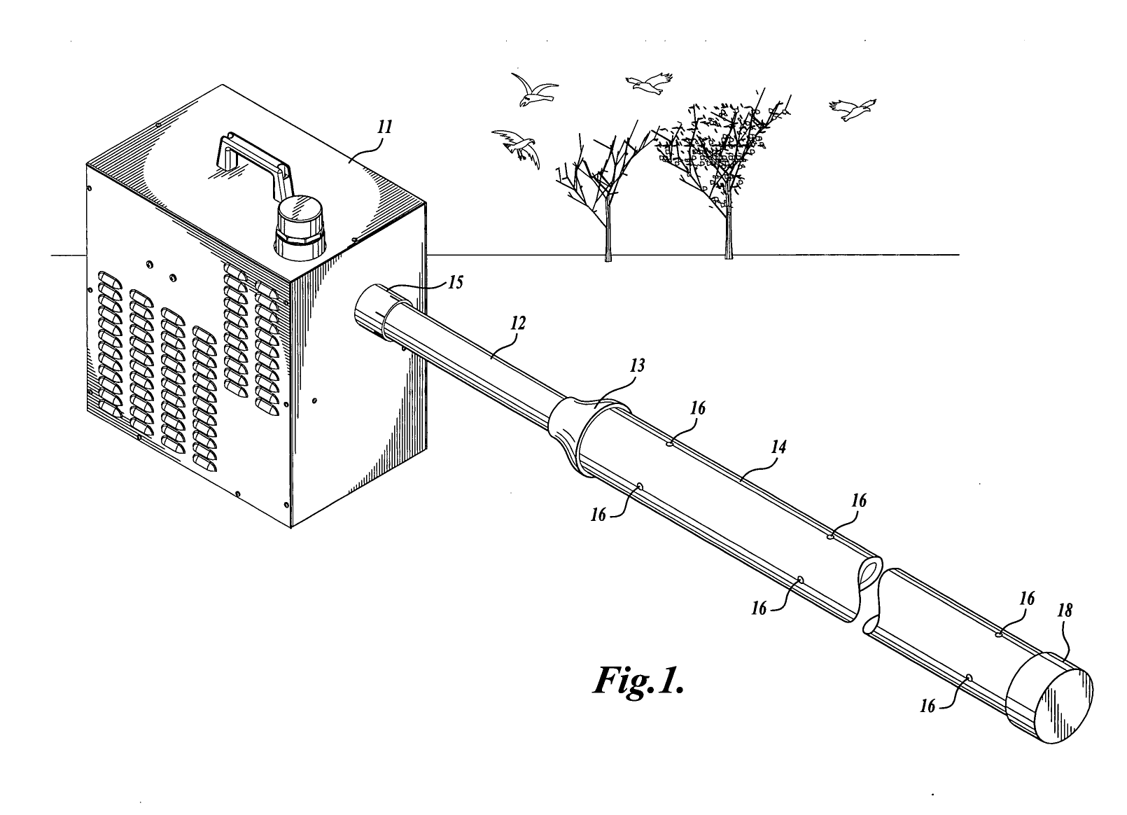

FIG. 1 illustrates a haze generator 11 formed in accordance with the invention connected to an elongate, relatively small diameter dispensing tube 14 formed of a suitably rigid material that is nonreactive to MA haze, such as polyvinyl chloride (PVC). The dispensing tube 14 is connected to the outlet 15 of the haze generator 11 via coupling 13 and a short tube 12 sized to match the outlet 15—2 inches in diameter, for example. The dispensing tube 14 includes a plurality of holes 16 located along the length of the tube 14. The end of the dispensing tube 14 is closed by an end cap 18. As more fully described below, preferably, the diameter of the tube 14 falls in the 3 inch to 4 inch range and has a length of less than 200 feet. The plurality of holes 16, which are preferably about ½ inch in diameter, are spaced apart by a suitable distance, such as 10 feet, for example.

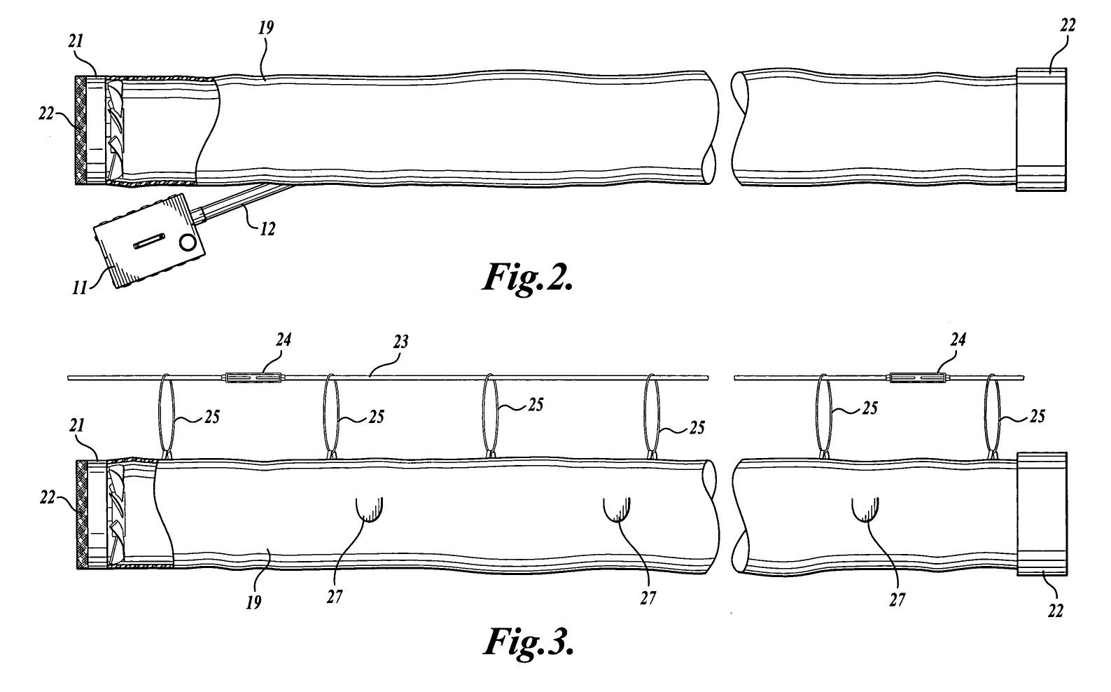

While relatively small diameter (e.g., 3- to 4-inch) rigid dispensing tubes 14, formed of PVC or some other suitable material, are suitable for use as a distribution system in some environments, particularly those having relatively short-run distance requirements, in other environments, particularly those having relatively long-run distance requirements, larger dispensing tubes are more desirable to in order to help keep MA particles separated and as small as initially generated to thereby maintain a dry haze. FIGS. 2 and 3 illustrate such dispensing tubes. More specifically, FIGS. 2 and 3 illustrate a haze generator 11 similar to the haze generator illustrated in FIG. 1 connected by the short outlet tube 12 to a large inflatable tube 19. Located at one end of the large inflatable tube 19 is a fan 21 with a filter 22 located on the intake side of the fan for removing contaminants. The filter may be formed of PVC filter foam, for example. The short tube 12 enters the large inflatable tube 19 downstream from the fan 21. When energized, the fan 21 inflates the large inflatable tube 19 and assists in separating the MA haze particles created by the haze generator 11 and moving the particles down the inflatable tube 19. As shown, the end of the large inflatable tube is closed by an end cap 22. While various sized fans can be used, in one actual embodiment of the invention, the fan produces approximately 25 mph wind and pressurizes a large inflatable tube to about 60 pounds per square inch (psi).

As best illustrated in FIG. 3, preferably the large inflatable tube 19 is hung from a suitable support cable 23 by loops 25 located along the length of the tube 19. The loops make take on many forms, such as wire ties, ropes, belts, etc. If desired, the support cable may include one or more turnbuckles for tightening the cables.

Located along the length of the large inflatable tube 19 are a plurality of U-shaped flaps 27 spaced apart by a distance of 10 feet or so. Preferably, the U-shaped flaps are roughly 2 inches by 2 inches in size. When the fan 21 is energized, the pressure created by the fan in the large inflatable tube 19 is sufficient to cause the inflatable tube to become semi-rigid and the U-shaped flaps to open. As a result, MA haze or mist produced by the haze generator 11 entering the large inflatable tube 19 is emitted from the U-shaped flaps when the fan 21 is energized. As noted above, a filter 22 is made from a material that is non-reactive to MA, is added to the intake of the fan to prevent dirt and debris from entering the system.

The diameter of the inflatable tube 19 may vary from 10 to 18 inches, for example. Obviously, the fan 21 is either sized to have the same diameter as the large inflatable tube 19, or reducers or expanders are used to adapt the output of the fan to the large inflatable tube 19. Preferably, the fan and the large inflatable tube are formed of materials that are non-reactive material to MA, such as rip-stop nylon coated with polyurethane. In particular, preferably, the blades of the fan are formed of material that is non-reactive to MA solutions, such as nylon, aluminum, or powder coated sheet metal, for example.

As will be readily appreciated from viewing FIG. 3, large inflatable tubes of the type illustrated in FIGS. 2 and 3 are ideally suited for suspension from the rafters of barns or other structures and, thus, are reasonably positionable to emit dry MA haze in the regions of such structures where birds tend to roost. As noted above, the separation of the MA particles that form an MA haze is important to maintaining the dryness of the haze. The air added by the fan 21 helps keep the haze dry by keeping the MA particles separated throughout the entire distribution system. The initial dry haze mixes with the added air, creating a larger volume of dry haze. Ideally, the MA haze emitted via the holes 16 (FIG. 1) or the U-shaped flaps 27 (FIG. 3) is substantially invisible in normal lighting conditions.

It has been found that large diameter inflatable tubes are more ideally suited for longer runs than smaller diameter rigid tubes, especially when a change in direction is desired. By way of example only, inflatable tubes having a diameter of 12-18 inches are ideally suited for runs in the 200-900 foot range, inflatable tubes having a diameter of 10 inches are ideally suited for runs in the 150-400 foot range, rigid tubes having a diameter of 4 inches are ideally suited for runs in the 100-150 foot range, and rigid tubes having a diameter of 3 inches are ideally suited for runs less than 100 feet. The increase in tube diameter allows the particles that form the MA haze to remain separated from each other for longer distances. The distance is directly related to the volume of the distribution system. As with the design of most air moving systems, tapering the size of the tubing is not necessary; however, tapering can be used if desired. Regardless of how structured the pressure of the air created by the fan should be sufficient to inflate the tubing and cause enough air movement throughout the tubing such that, when the dry haze exits through the U-shaped flaps 27 the exiting velocity is sufficient for the dry haze to travel long distances and cover large areas. As noted above, in one actual embodiment of the invention, the fan generates approximately 25 mph wind and the inflatable tube is inflated to about 60 psi. The MA haze exiting this embodiment has a velocity in the 8-9mph range. There is about 3 foot pounds of back pressure buildup on the blades of the fan.

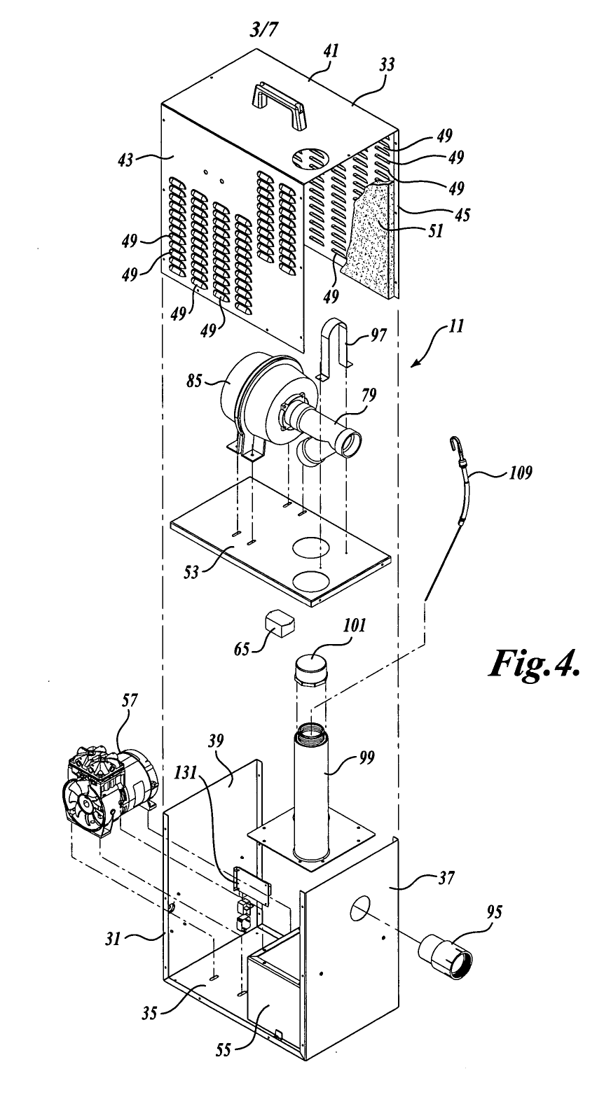

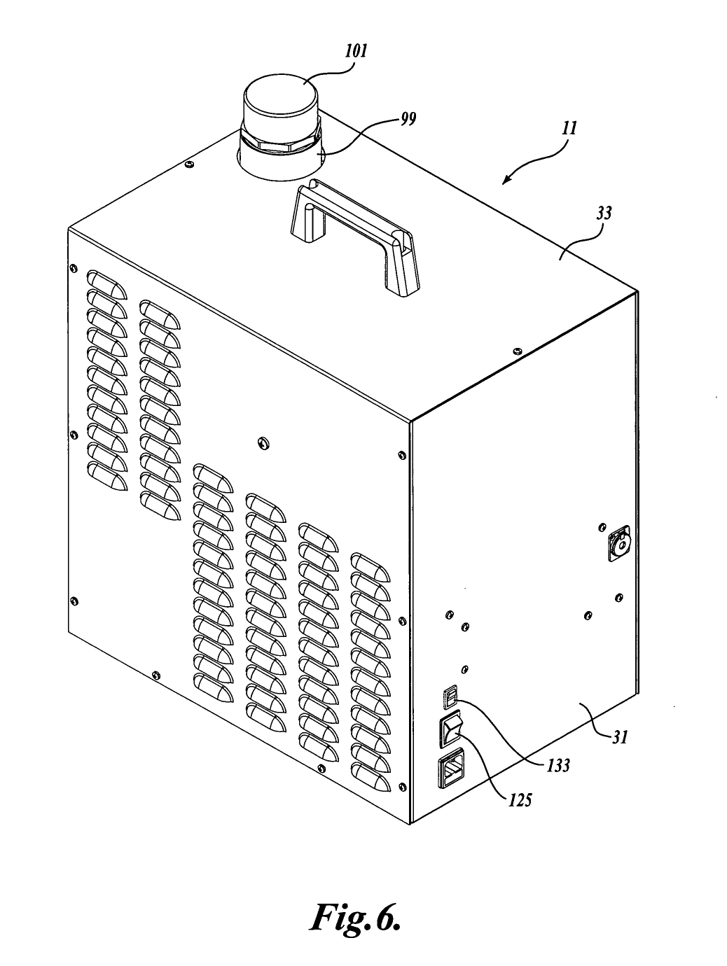

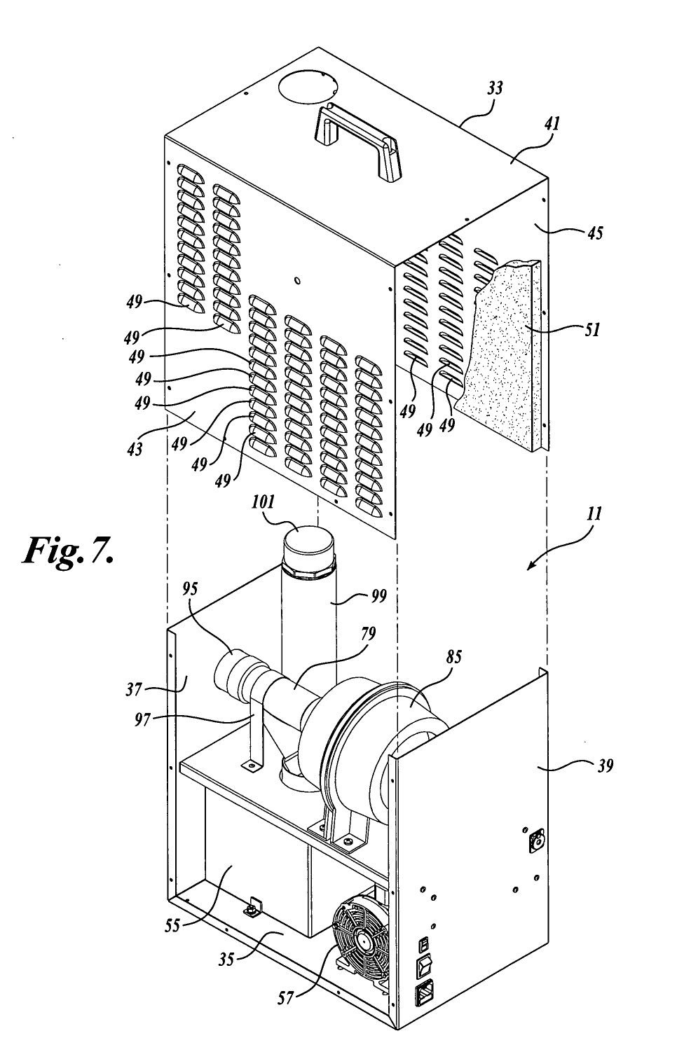

FIGS. 4-7 illustrate the haze machine 11. The haze machine 11 includes a two-piece housing comprising a base 31 and a cover 33. Both the base 31 and the cover 33 are formed of a suitable material that is nonreactive to methyl anthranilate (MA), such as sheet metal coated with powder. Both the base 31 and the cover 33 have a right angle U-shape. More specifically, the base 31 includes a bottom 35 and front and rear walls 37 and 39. The cover 33 includes a top 41 and side walls 43 and 45. The bottom 35 and front and rear walls 37 and 39 include inwardly extending flanges to which the adjacent edges of the side walls 43 and 45 are attached via, for example, sheet metal screws. When the base 31 and cover are joined, the housing has the overall shape of a right rectangular parallelepiped. The side walls 43 and 45 of the housing include a plurality of louvers 49 covered on the inside with a layer of filter material 51 that removes contaminants from air entering the housing.

Mounted in the housing so as to lie parallel to the base 35 is a shelf 53. Located beneath the shelf 53 is a haze generator 55 and a compressor 57. The compressor 57 is attached, by bolts, for example, to the bottom 35 of the base 31 of the housing.

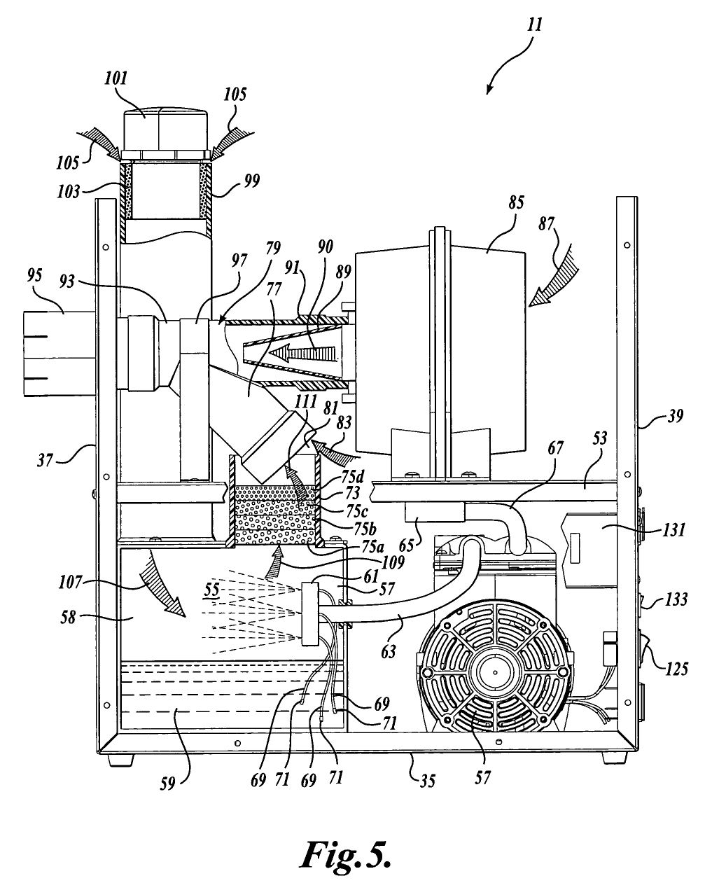

The haze generator 55 includes a chamber 58, the lower portion of which forms a reservoir for an MA solution 59. The chamber 58 has the shape of a right rectangular parallelepiped. Like the base and cover, the top, bottom, and side walls of the chamber are formed of a suitable material that is nonreactive to MA—such as stainless steel, aluminum, or sheet metal coated with powder, for example. Located inside of the chamber 58, above the MA solution 59, is a venturi head 61. The venturi head includes one or more venturi nozzles, three in the exemplary head 61 shown in FIG. 5. The venturi head 61 is connected to a tube 63 connected to the output port of the compressor 57. The inlet port of the compressor is connected to a filter 65 via an inlet tube 67.

Returning to the venturi head 61, in addition to receiving pressurized air from the compressor 57, a plurality of pickup tubes 69 equal in number to the number of venturi nozzles in the venturi head, i.e., three in the illustrated exemplary head, extend into the MA solution 59. Preferably, the ends of the pickup tubes 69 that extend into the MA solution each include a filter 71. As described in more detail in the patent and provisional applications referenced above, the pressurized air produced by the compressor 57 creates a Bernoulli effect in the venturi nozzles of the venturi head 61. The Bernoulli effect causes very small amounts (i.e., droplets) of fluid to be withdrawn from the MA solution 59 and broken into a mist or haze 72 formed by MA particles. The mist or haze 72 is emitted from the venturi nozzles of the venturi head 61. While various pressures can be used, preferably, the compressor pressure is in the 22-30 pounds per square inch (psi) range, preferably 29 psi.

As shown by an arrow 109, the mist or haze 72 exits the chamber 58 via a short tube 73 mounted in the top of the chamber 58. Preferably, the short tube 73 includes a plurality of filter layers 75a, 75b, 75c . . . , each decreasing in size from the bottom of the short tube nearest the interior of the chamber 57 to the top of the short tube 73, as represented by the decreasingly sized holes in the filter layers 75a, 75b, 75c . . . shown in FIG. 5. Preferably, the filter layers 75a, 75b, 75c, . . . are formed of material that is non-reactive to MA, such as PVC filter foam.

Extending into the top of the short vertical tube 73 is an angled leg 77 of a generally Y-shaped coupling 79. A space 81 for drawing air into the angled leg 77 is located between the angled leg 77 and the top of the short tube 73. The intake air is represented by an arrow 83 in FIG. 5. The intake air 83 is mixed with the MA particles, represented by an arrow 111, that have passed through the filter layers 75a, 75b, 75c . . . . Preferably, the generally Y-shaped coupling is formed of a rigid material, such as PVC.

Mounted atop the shelf 53 is a blower 85. The blower 85 is a vacuum-type blower. More specifically, the blower 85 has an enlarged opening on one side for receiving air represented by an arrow 87. The blower 85 pressurizes the air and emits a stream of air 90 via a truncated cone nozzle 89 positioned over the outlet of the blower 85. The truncated cone nozzle 89 extends into a second leg 91 of the generally Y-shaped coupling 79. Like the generally Y-shaped coupling, the truncated cone nozzle is formed of a suitably rigid material, such as PVC. While various types of vacuum and other blowers can be used, in one actual embodiment employing a vacuum blower, the velocity of the stream of air exiting the truncated cone nozzle was about 90 mph. Obviously, this speed should be construed as exemplary, not limiting, since various speeds can be used. The speed and air volume emitted from the truncated cone nozzle must be sufficient to inject MA haze into the distribution system, which requires overcoming any back pressure in the distribution system caused, for example, by the fan 21 illustrated in FIGS. 2 and 3 and described above.

The third leg 93 of the generally Y-shaped coupling is connected to an output coupling 95 that forms the outlet 15 of the haze generator 15. The air stream produced by the blower 85 that exits the truncated cone nozzle creates a venturi that, in effect, draws the MA haze or mist produced by the MA vaporization process through the filter layers 75a, 75b, 75c, and mixes the MA haze with additional air, filtered from inside of the body of the MA generator 55 to help separate the MA particles and keep them apart for a longer period of time. The filter layers 75a, 75b, 75c . . . remove large MA particles and excess spray MA particles from the haze or mist. Excess spray particles are particles that impinge on the surfaces of the interior walls of the chamber 58. The removed large and excess spray particles drop or slide down the side walls of the chamber 58, back into the MA solution 59. As a result, only relatively small MA particles are emitted from the outlet 15. The filtering is such that the majority of the small MA particles are less than 20 microns in size, preferably below 10 microns. The generally Y-shaped coupling is held in place by a U-shaped bracket 97, which may be formed of sheet metal. The output coupling 95, like the short tube 73, the generally Y-shaped tube 79, and the truncated cone nozzle 89, is formed of a rigid material that is nonreactive to MA, such as polyvinyl chloride (PVC), for example.

Extending upwardly from the top of the chamber 58 is a long tube 99 that is enclosed at its upper end by a cap 101. Located between the cap 101 and the inner side of the upper part of the long tube 99 is a filter 103. The filter 103 allows air to be drawn into the long tube 99, as shown by the arrows 105. Air entering the tube exits the lower end of the tube, as shown by arrow 107, and enters the chamber 58. The long tube 99 is used to add MA solution to the chamber 58. Preferably, a dipstick 109, which is accessible when the cap 101 is removed, is used to check the level of the MA solution 59 in the chamber 58.

In summary, when the compressor 57 and the blower 85 are energized, pressure produced by the compressor 57 causes the venturi head 61 to create an MA mist or haze in the region of the chamber 58 above the MA solution 59. The MA mist or haze exits the chamber 58 via the filters in the short tube 73, as shown by the arrows 109 and 111. Exiting is assisted by the air stream 90 created by the blower 85 via the truncated cone nozzle 89. The resultant fine MA mist or haze, which includes a majority of MA particles less than 20 microns in size, exits the haze generator 11 via the outlet coupling 95. The air added to the dry haze exiting the chamber 58 via the filters in the short tube increases the distance between the MA particles that form the haze to thereby prevent the coagulation, i.e., combining of the particles. The high-speed air stream emitted by the truncated cone nozzle injects the resulting dry haze into the distribution system. Distribution systems that include a fan, such as the distribution system illustrated in FIGS. 2 and 3 and described above, adds additional air to the haze thereby separating the MA particles further. The end result is an almost invisible haze exiting the distribution system. Invisibility is important because it prevents the eyesight of birds from determining whether or not MA is present in a particular area, as in the case of fog. While it is possible that dry MA haze particles leaving the filter layers in the short tube 73 might coagulate, particularly after the haze machine is de-energized, droplets resulting from such coagulation drain back through the filter layers into the chamber 58 and become part of the MA solution 59.

The haze generator 11 illustrated in FIGS. 4-7 includes a number of features, some or all of which may be included in actual embodiments of the invention. Among these features are the use of filters positioned to prevent MA mist or haze from impacting the operation of the compressor 57 and the blower 85. Notable in this regard are the filters 51 located inside of the louvers 49 of the housing. Filter 65 insures that air entering the compressor is clean. The filter 103 at the top of the long tube 99 insures that air entering the housing via the long tube is also clean of dirt or debris, as well as other contaminants. The venturi effect of the air stream created by the truncated cone nozzle 89 insures that air 85 is drawn into the angled MA mist or haze leg 77 of the generally Y-shaped coupling rather than the MA haze or mist entering the housing. The filter foam 51 is located along the inside walls of the cover 33 adjacent to the inside of the louvered vents 49 filter dirt, debris and other contaminates from air entering the housing.

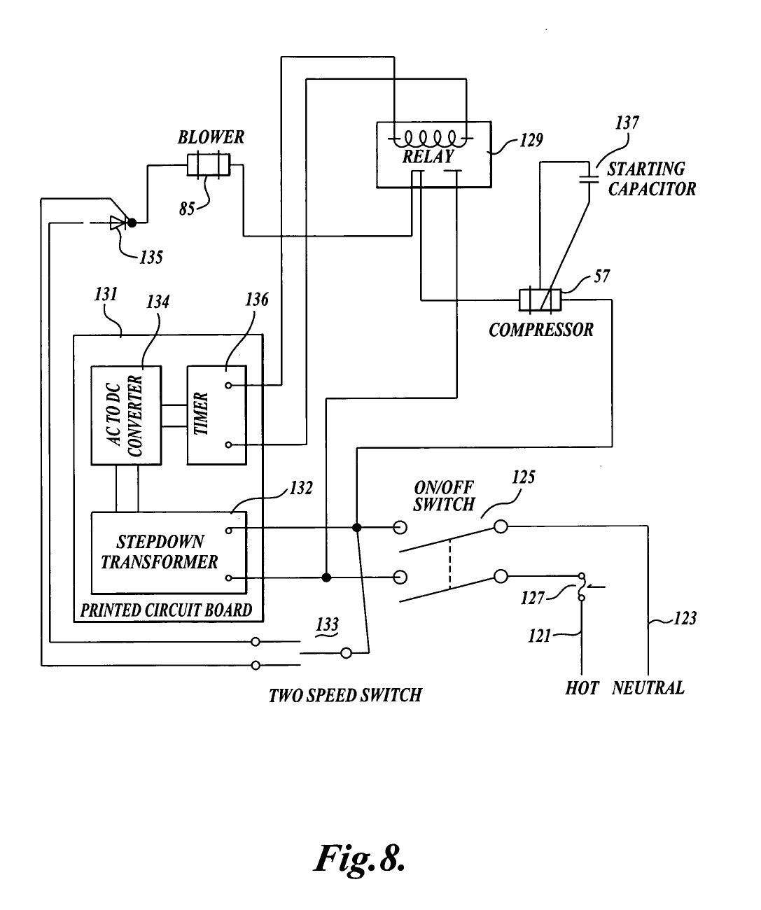

FIG. 8 is a control circuit for controlling the operation of the haze generator 11. AC power hot and neutral lines 121 and 123 are connected to the haze generator via a double-pole, double-throw On/Off switch 125. Preferably, one of the AC power lines, such as the hot power line 121, is protected by a fuse, circuit breaker or other protective device 127. The hot output of the On/Off switch 125 is connected to one of the power terminals of a relay 129 and to one of the power terminals of a printed circuit board (PCB) 131. In the illustrated exemplary embodiment, the PCB includes a stepdown transformer 132, an AC to DC converter 134 and a timer 136 and the power terminals are connected to the input terminals of the step down transformer. The neutral output of the On/Off switch 125 is connected to the other power terminal of the other input of the step down transformer 132, the neutral terminal of the compressor 57, and to one terminal of a single-pole, double-throw two-speed switch 133. One of the poles of the two-speed switch is directly connected to the neutral or hot terminal of the blower 85, and the other terminal is connected to the neutral or hot terminal of the blower 85 via a rectifier diode 135. The opposite terminals of the blower and the compressor are connected to the other power terminal of the relay 129.

The output of the step down transformer 132 is connected to the input of the AC to DC converter 134, which connects the AC input to a DC output. The DC output of the AC to DC converter is connected to the power input of the timer 136. Preferably, the on/off time cycle of the time is adjustable, preferably remotely adjustable (not shown). The coil terminals of the relay 129 are connected to the output of the printed circuit board/timer 136. FIG. 8 also illustrates the starting capacitor 137 of the compressor 59.

In operation, when the On/Off switch 125 is closed and the timer 136 is set to apply power to the relay 129, the relay closes, resulting in power being applied to the blower and the compressor. Either full power or half power is applied to the blower 85, depending on the position of the two-speed switch. Half power is applied when the two-speed switch is positioned to apply power via the rectifier 135 because the rectifier reduces the RMS value of the AC input voltage by one-half. The timer is an On/Off timer that causes the haze generator to be energized in intermittent fashion, depending upon the environment of use. As noted above, preferably, a remote control unit connectable to a connector on the printed circuit board 131 is used to remotely adjust the cycle time of this On/Off timer.

While a preferred embodiment of the invention has been illustrated and described, it will be appreciated that various changes can be made therein within the scope of the invention as defined by the appended claims. For example, rather than the straight small and large diameter dispensing tubes illustrated in FIGS. 1-3, the dispensing tubes can include elbows and branches, if desired.

The embodiments of the invention in which an exclusive property or privilege is claimed are defined as follows:

1. A method of dispensing a dry haze bird repellent, comprising:
generating a dry haze containing small particles containing a bird repellent;
filtering the dry haze to remove particles above a predetermined size; and
blowing air into the filtered dry haze to separate the particles containing a bird repellent and direct the particles containing a bird repellent into a closed distribution system.

2. The method claimed in claim 1 wherein the haze is generated inside of a chamber by a venturi head.

3. The method of claim 2 wherein the venturi head includes a plurality of venturi nozzles and wherein the method comprises:
supplying pressurized air to the venturi nozzles; and
supplying a bird repellent solution to the venturi nozzles.

4. The method of claim 3 wherein the bird repellent solution is a solution that includes methyl anthranilate.

5. The method of claim 1 wherein filtering the haze to remove droplets above a predetermined size comprises passing the haze containing droplets through a plurality of filters.

6. The method of claim 5 wherein the plurality of filters are layered.

7. The method of claim 6 wherein the filtered layers become progressively smaller in filter size in the direction of filtering.

8. The method of claim 1 wherein blowing the filtered haze into an enclosed distribution system comprises:
generating a high speed stream of air;
combining the high speed stream of air with the filtered haze to create a new dry haze having less small particles containing a bird repellent per unit of volume than the original dry haze; and
directing the new dry haze into a tubular distribution system.

9. The method of claim 8 wherein the tubular distribution system includes a set of rigid tubes, said rigid tubes including openings located along the length of rigid tubes.

10. The method of claim 8 wherein the tubular distribution system includes an inflatable tube, said inflatable tube including flaps located along the length of the inflatable tubes.

11. The method of claim 10, including:
generating fan air;
filtering the air coming into the fan; and
directing the filtered fan air into the inflatable tube to inflate the inflatable tube.

12. Apparatus for dispensing a bird repellent, comprising:
a haze generator for generating a haze containing small particles including a bird repellent chemical;
a filter for filtering the haze containing small particles including a bird repellent chemical to remove particles above a predetermined size;
a blower system for creating a high speed air stream, combining the high speed air stream with said filtered haze to increase the separation between said small particles containing a bird repellent to create a dry haze and direct said dry haze into a distribution system; and
a distribution system for receiving and distributing said filtered dry haze including a bird repellent.

13. Apparatus as claimed in claim 12 wherein said distribution system comprises a rigid tube with holes located along the length of the tubes.

14. Apparatus as claimed in claim 12 wherein said distribution system comprises:
an inflatable tube with a plurality of flaps located along the length of the tube; and
a fan for inflating the tube and increasing the separation between said small particles containing a bird repellent.

15. Apparatus as claimed in claim 12, wherein said blower system includes a blower, a nozzle attached to the output of said blower for creating said high speed air stream and a coupling for combining the high speed air stream created by said nozzle with said filtered haze.

16. Apparatus as claimed in claim 12 wherein said filter comprises a plurality of layers.

17. Apparatus as claimed in claim 16 wherein the filter size of said layers of said plurality of layers decreases.

18. Apparatus as claimed in claim 12, including a compressor and wherein said haze generator includes:
a chamber for holding a bird repellent solution;
a venturi head connected to said compressor; and
at least one pickup tube extending between said repellent solution and said venturi head for delivering said bird repellent solution to said venturi head.

19. Apparatus as claimed in claim 18, including a tube vertically positioned atop said chamber, said filter being located in said tube.

20. Apparatus as claimed in claim 19, including a generally Y-shaped coupling coupling said tube vertically positioned atop said chamber and the output of said blower.

21. Apparatus as claimed in claim 18, including a dip stick for determining the level of said bird repellent solution in said chamber.

22. Apparatus as claimed in claim 18, including an On/Off timer for controlling the energization of the blower and the compressor.

23. Apparatus as claimed in claim 12, including an On/Off timer for controlling the energization of the blower.

24. In an apparatus for dispensing a dry bird repellent haze, including a haze generator for generating a haze containing small particles including a bird repellent chemical, the improvement comprising:
a blower for creating a stream of air; and
a distribution system for receiving said haze containing small particles including a bird repellent chemical and said stream of air for distributing said small particles including a bird repellent.

25. The improvement claimed in claim 24, wherein the distribution system comprises a rigid tube with holes located along the length of the tube.

26. The improvement claimed in claim 24, wherein the distribution system comprises:
an inflatable tube with a plurality of flaps located along the length of the tube; and
a fan for inflating the tube.

27. The improvement claimed in claim 24, including a nozzle attached to the output of the blower for creating said stream of air and a coupling for mixing the stream of air created by said nozzle and said haze containing said small particles to form a dry haze.

28. The improvement claimed in claim 24, including an On/Off timer for controlling the energization of the blower.
